(19) United States
(12) Patent Application Publication
(10) Pub. No.: US 2013/0192372 A1
(43) Pub. Date: Aug. 1, 2013

(54) RESONANT SENSOR MEASUREMENT DEVICE

(71) Applicant: COMMISSARIAT A L'ENERGIE ATOMIQUE ET AUX ENE ALT, Paris (FR)

(72) Inventors: Eric COLINET, Bois Guillaume (FR); Julien Arcamone, St Martin Le Vinoux (FR); Gregory Arndt, Grenoble (FR)

(73) Assignee: COMMISSARIAT A L'ENERGIE ATOMIQUE ET AUX ENE ALT, Paris (FR)

(21) Appl. No.: 13/748,836

(22) Filed: Jan. 24, 2013

(30) Foreign Application Priority Data
Jan. 27, 2012 (FR) 12 50801

(51) Int. Cl. G01H 13/00

(52) U.S. Cl. CPC G01H 13/00
USPC 73/579

(57) ABSTRACT

Device for the measurement of at least one physical variable, comprising at least:
a first and a second resonant sensor, one of the two resonant sensors being sensitive to a variation of the physical variable to be measured and the other of the two resonant sensors not being sensitive to a variation of the physical variable to be measured;
means capable of imposing the same resonant frequency on the first and the second resonant sensors;
means of measuring a phase shift between the output signals from the first and the second resonant sensors.

### TECHNICAL FIELD

This invention relates to the field of resonant sensor measurement devices or resonators capable of measuring one or several physical variables, for example a mass, acceleration, pressure, temperature, etc.

The invention is advantageously used in the field of gas or liquid phase chemical sensors, molecular force sensors, mass spectroscopy or inertial sensors (accelerometers, gyroscopes). The invention also relates to a measurement method used with resonant sensors.

### STATE OF PRIOR ART

A MEMS and/or NEMS type resonator is an electromechanical device comprising a mobile part forming a vibrating mechanical structure and two electromechanical transduction elements. The first of these two electromechanical transduction elements generates a force on the mobile part, thus creating a movement of this mobile part, the second electromechanical transduction element detecting the movement of the mobile part. The actuation transduction done by the first element may correspond to an electrostatic, magnetic, thermomechanical or even piezoelectric actuation.

The detection transduction done may for example correspond to a capacitive, piezoresistive, magnetomotive or even piezoelectric detection.

The resonant sensor is characterised particularly by its resonant frequency fᵣ, that depends mainly on the mass of the mobile part of the sensor, geometric parameters of mechanical parts of the sensor and physical parameters of materials forming the various parts of the sensor (Young's modulus, etc.), and by its quality factor Q depending on energy losses of the resonant sensor. The resonant frequency fᵣ depends also on the temperature, pressure, stress in the mobile structure and the power supply voltage applied to the resonant sensor.

Therefore the dependence of the resonant frequency fᵣ of a resonant sensor on these variables can be used to measure one of these physical variables (for example a mass, acceleration, temperature, etc.). For example, in the case of a measurement of a uniform addition of mass on the resonant sensor, this addition increases the mass of the mobile part of the sensor, which reduces its resonant frequency. fᵣ. The resonant frequency fᵣ is measured dynamically by initially making the sensor resonant in oscillation at this resonant frequency fᵣ. The measurement of the variation of the resonant frequency fᵣ of the resonator can be used to deduce the mass added onto the sensor.

A first device called a self-oscillating loop measures the resonant frequency fᵣ of a resonant sensor 10 and is shown in FIG. 1. This self-oscillating loop comprises the resonant sensor 10, for example of the MEMS type, counter-reaction electronics 11 composed of an amplifier 12 and a phase shifter 14, and a frequency counter 16. The counter-reaction electronics 11 compensates for the attenuation in gain (due to the amplifier 12) and the phase shift (using the phase shifter 14) introduced by the resonant sensor 10 into the loop at the resonant frequency fᵣ so that resonance conditions (gain more than 1 and phase passing through the value −n/2) of the resonant sensor 10 are satisfied. The resonant frequency fᵣ of the resonant sensor 10 is measured using the frequency counter 16.

A second device called the frequency locking loop is shown in FIG. 2 and is also used to measure the resonant frequency fᵣ of a resonant sensor 20. This frequency locking loop comprises the resonant sensor 20, for example similar to the resonant sensor 10, an amplifier 22, a phase comparator 24, a filter 26 and a voltage-controlled oscillator (VCO) 28 connected in series in a loop. The output signal from the VCO 28 is sent to the input of the resonant sensor 20 and to the input of the phase comparator 24. In such a device, the phase comparator 24, the filter 26 and the VCO 28 slave the phase shift of the resonant sensor 20 onto its phase shift at the resonant frequency fᵣ. The resonant frequency fᵣ is measured at the output from the filter 26, for example by a frequency counter not shown in FIG. 2.

The previously described devices give a measurement of a variation of a physical variable through the measurement of the variation of the resonant frequency of a resonant sensor.

However, with such devices, it is difficult to isolate the influence of the physical variable to be measured (for example the added mass) from the variation of the resonant frequency measured relative to the other physical variables (for example the temperature, pressure, etc.). The resonant frequency fᵣ of a resonator may be expressed in the form of the following equation:

fᵣ=fᵣ₀(1+αΔT+βΔm+γΔV_{DC}) (1)

where fᵣ₀: resonant frequency of the resonant sensor under its normal operating conditions;

ΔT: temperature variation applied to the resonant sensor;

Δm: mass variation applied to the resonant sensor;

ΔV_{DC}: variation of the power supply voltage of the resonant sensor.

The values of the coefficients α, β and γ depend on the influence of these parameters on the resonant frequency fᵣ. The equation (1) above is a simplified expression of the resonant frequency fᵣ that only takes account of some parameters that have an influence on the resonant frequency fᵣ of the resonant sensor.

The variation of the environmental operating conditions of the resonant sensor modifies the value of the resonant frequency fᵣ of the sensor. For example, if it is required to measure the mass variation Δm applied to the resonant sensor, equation (1) shows that a temperature variation occurring at the same time as the mass variation to be measured can distort this measurement because it is impossible to distinguish the influence of the variation of the parameter to be measured on the resonant frequency of the resonant sensor, from variations of other parameters that also have an influence on the resonant frequency fᵣ of the sensor.

One means of overcoming this problem is to make use of two oscillators (for example corresponding to two structures similar to one of those shown in FIGS. 1 and 2) each comprising a distinct resonant sensor with the same resonant frequency fᵣ₀ under the same standard operating conditions. One of these two resonant sensors is modified so that it is insensitive to the variation of the physical variable to be measured. For example, if measuring a mass variation, one of the two sensors may be covered by a cover capable of resisting the mass to be measured without it having any effect on the resonant sensor. Therefore this resonant sensor is sensitive to all physical variables (for example temperature, pressure, etc.) apart from the variable to be measured, in this case the mass. In using the simplified expression of the resonant frequency fᵣ given by the above equation (1), the resonant frequency fᵣ₁ of the resonant sensor insensitive to a mass variation is therefore such that:

fᵣ₁=fᵣ₀(1+αΔT+γΔV_{DC}) (2)

Unlike this resonant sensor, the other sensor is sensitive to all physical variables that have an influence on its resonant frequency, including the variable to be measured. Therefore, its resonant frequency fᵣ₂ is such that:

fᵣ₂=fᵣ₀(1+αΔT+βΔm+γΔV_{DC}) (3)

The resonant frequencies fᵣ₁ and fᵣ₂ of each of the resonant sensors are measured when the variable to be determined varies. Therefore the relative variation of resonant frequencies of the two resonant sensors determines the variation of the required variable such that:

fᵣ₂−fᵣ₁=fᵣ₀βΔm (4)

Although this is effective to obtain the required measurement, this solution requires the production of two oscillators each with a frequency counter, which represents a significant production cost.

### PRESENTATION OF THE INVENTION

One purpose of this invention is to disclose a resonant sensor measurement device to measure the variation of at least one physical variable, for example a mass, temperature, pressure or even acceleration variation that does not require the production of two distinct frequency counters.

To this purpose, it is proposed a device for the measurement of at least one physical variable, comprising at least:
a first and a second resonant sensor, one of the two resonant sensors being sensitive to a variation of the physical variable to be measured and the other of the two resonant sensors not being sensitive to a variation of the physical variable to be measured;
means capable of imposing the same resonant frequency on the first and the second resonant sensors;
means of measuring a phase shift between the output signals from the first and the second resonant sensors.

The present invention also proposes a device for the measurement of at least one physical variable, comprising at least:
a first and a second resonant sensor, one of the two resonant sensors being sensitive to a variation of the physical variable to be measured and the other of the two resonant sensors not being sensitive to a variation of the physical variable to be measured;
means capable of imposing a same resonant frequency on the first and the second resonant sensors;
means of measuring a phase shift between the output signals from the first and the second resonant sensors;

in which the means capable of imposing the same resonant frequency on the first and the second resonant sensors comprise at least:
two amplifiers, the inputs of which are connected to outputs of the first and the second resonant sensors, and
a phase shift circuit, one input of which is connected to an output of one of the two amplifiers and one output of which is connected to the inputs of the first and second resonant sensors;

or in which the means capable of imposing the same resonant frequency on the first and the second resonant sensors comprise at least:
a differential amplifier comprising a non-inverting input connected to an output of the first resonant sensor, an inverting input connected to an output of the second resonant sensor, an inverting output connected to an input to the first resonant sensor, and a non-inverting output connected to an input to the second resonant sensor, and
a first capacitor connected to the inverting output of the differential amplifier, and a second capacitor connected to the non-inverting output of the differential amplifier;

and when the means of imposing the same resonant frequency onto the first and the second resonant sensors comprise said two amplifiers and said phase shift circuit, the means of measuring the phase shift between the output signals from the first and the second resonant sensors are capable of measuring a phase shift between signals output onto the outputs from the two amplifiers.

Thus, the measurement of the physical variable is obtained from the measurement of the phase shift between the output signals from the resonant sensors, and not using a calculation made through individual measurements of resonant frequencies of the two resonant sensors. Therefore the device according to the invention gives a differential harmonic detection of resonance that does not require a direct frequency measurement.

By making the measurement of the phase shift of the output signals from resonant sensors directly, the invention limits the influence of unwanted environmental parameters on the measurement made without using frequency counters.

Said other of the two resonant sensors may comprise means of making the resonant structure of said sensor insensitive to a variation of the physical variable to be measured.

The invention is advantageously applicable for making a measurement of a gas concentration such as DMMP (dimethyl methylphosphonate) in which a sensitive layer of gas is deposited on one of the resonant sensors and not on the other.

The first and/or the second resonant sensors may be of the NEMS and/or MEMS type. Each of the first and/or second resonant sensors may comprise at least one mobile part forming a vibrating mechanical structure and at least two electromechanical transduction elements, one of the two elements being capable of making said vibrating mechanical structure vibrate as a function of an input signal applied on the sensor, and the other of the two elements being capable of generating an output signal as a function of the vibration of the mechanical structure. However, the resonant sensors of the measurement device according to the invention may be based on any type of actuation and detection.

The physical variable that will be measured may be a mass, temperature, acceleration or pressure.

In a first embodiment, the means capable of imposing the same resonant frequency on the first and second resonant sensors may comprise at least one periodic signal generator connected to inputs of the first and second resonant sensors.

In another embodiment, the means capable of imposing the same resonant frequency on the first and second resonant sensors may comprise at least:
two amplifiers, the inputs of which are connected to outputs from the first and the second resonant sensors;
a phase shift circuit, an input of which is connected to an output of one of the two amplifiers and an output of which is connected to the inputs to the first and the second resonant sensors;

and in which the means of measuring the phase shift between the output signals from the first and the second resonant sensors are capable of measuring a phase shift between the signals output on the outputs from the two amplifiers.

The measurement device may comprise means of calculating a variation of said physical variable from the measured phase shift.

In another embodiment, the means capable of imposing the same resonant frequency on the first and second resonant sensors may comprise at least:
a differential amplifier comprising a non-inverting input connected to an output of the first resonant sensor, an inverting input connected to an output of the second resonant sensor, an inverting output connected to an input to the first resonant sensor, and a non-inverting output connected to an input to the second resonant sensor;
a first capacitor connected to the inverting output of the differential amplifier, and a second capacitor connected to the non-inverting output of the differential amplifier.

The device may also comprise means of calculating a variation of the physical variable using a difference between values of the power supply voltage of the resonant sensors.

The device may also comprise means of electrically powering one of the two resonant sensors by a power supply signal, the value of which depends on the value of a power supply signal from the other of the two resonant sensors and the phase shift between the output signals from the first and the second resonant sensors.

Means for measuring the phase shift between the output signals from the first and the second resonant sensors may comprise at least one phase comparator.

A method for measuring at least one physical variable is also proposed, comprising at least the following steps:
oscillation of a first and a second resonant sensor at the same resonant frequency, one of the two resonant sensors being sensitive to a variation of the physical variable to be measured and the other of the two resonant sensors not being sensitive to the variation of the physical variable to be measured;
measurement of a phase shift between the output signals from the first and the second resonant sensors.

The invention also relates to a method for measuring a variation of at least one physical variable, comprising at least the following steps:
oscillation of a first and a second resonant sensor at the same resonant frequency, one of the two resonant sensors being sensitive to a variation of the physical variable to be measured and the other of the two resonant sensors not being sensitive to a variation of the physical variable to be measured;
measurement of a phase shift between the output signals from the first and the second resonant sensors;

and in which the first and the second resonant sensors are put into oscillation at the same resonant frequency, as follows:
by applying the same signal output from a counter reaction loop made with the first or the second resonant sensors to the input to the first and the second resonant sensors, or
by applying a signal output from a counter reaction loop produced with each of the first and the second resonant sensors respectively, to the input to each of the first and the second resonant sensors, and a differential amplifier to which the output signals from the first and the second resonant sensors are input.

### BRIEF DESCRIPTION OF THE DRAWINGS

This invention will be better understood after reading the description of embodiments given purely for information and in no way limitative with reference to the appended drawings in which:

FIGS. 1 and 2 show two resonant sensor measurement devices according to prior art;

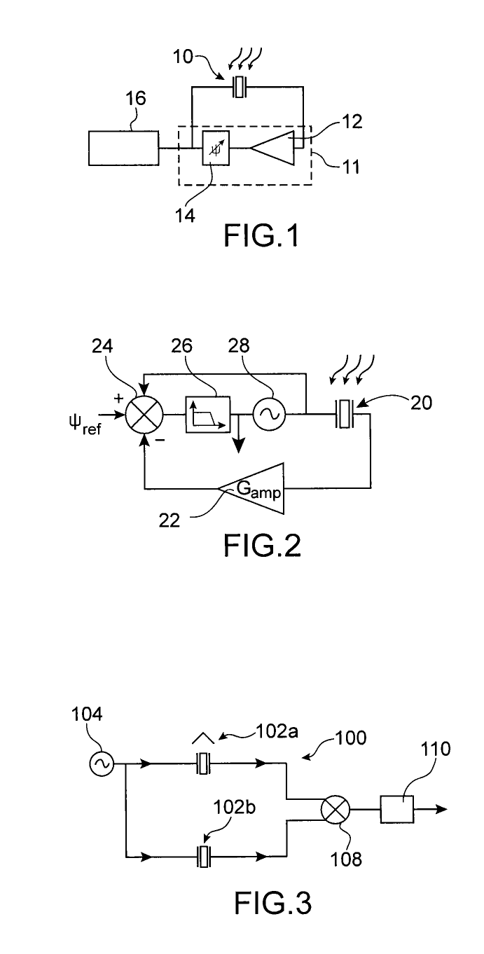

FIGS. 3 to 6 show various embodiments of resonant sensor measurement devices according to this invention.

Identical, similar or equivalent parts of the different figures described below have the same numeric references to facilitate comparison between different figures.

The different parts shown in the figures are not necessarily at the same scale, to make the figures more easily readable.

The different possibilities (variants and embodiments) must be understood as not being exclusive of each other and they can be combined with each other.

### DETAILED PRESENTATION OF PARTICULAR EMBODIMENTS

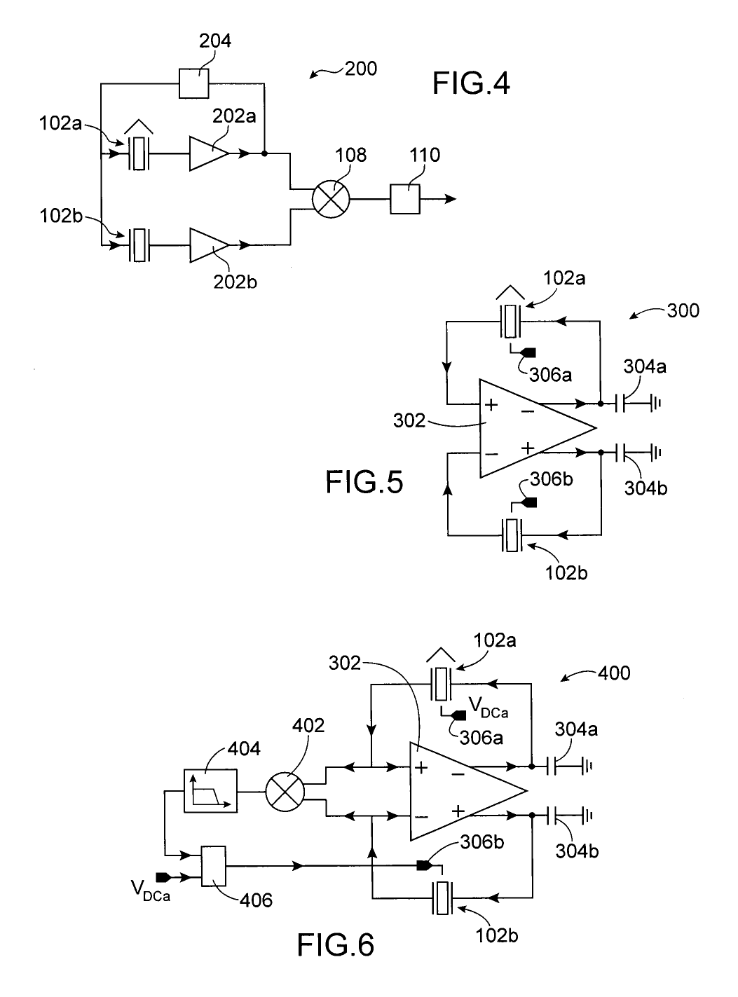

Firstly refer to FIG. 3 that shows a first embodiment of a resonant sensor measurement device 100 capable of measuring a physical variable.

The measurement device 100 comprises a first resonant sensor 102a, also called a resonator, for example of the MEMS and/or NEMS type, and a second resonator 102b, also of the MEMS and/or NEMS type. These two resonant sensors 102a, 102b may for example be similar, in other words in particular they may have the same resonant frequency fᵣ. Each of the resonant sensors may comprise at least one mobile part forming a vibrating mechanical structure and at least two transduction elements, for example electromechanical, one of the two elements forming an input transduction element capable of making the vibrating mechanical structure vibrate as a function of an input signal applied to the input element of the sensor, and the other of the two elements forming an output transduction element capable of generating an output signal as a function of the measured vibration of the vibrating mechanical structure.

Unlike the second resonant sensor 102b that is sensitive to variations of all the surrounding physical variables of the resonator and that have an influence on its resonant frequency (for example mass, temperature, etc.), the first resonant sensor 102a is insensitive to variations of the physical variable to be measured by the measurement device 100. In the example described herein, the measurement device 100 will measure a mass applied on it. Thus, the first resonant sensor 102a comprises means of making it insensitive to applied variations of the mass, these means for example corresponding to a cover or a housing in which at least the resonant mechanical structure of the first resonant sensor 102a is placed.

A mass applied on the first resonant sensor 102a thus applies a force on the cover or the housing that is not retransmitted to the resonant structure of the first resonant sensor 102a, thus not modifying the resonant frequency of the first resonant sensor 102a. If the measurement device 100 is aimed at measuring a temperature variation, the vibrating mechanical structure of the first resonant sensor 102a may for example be protected by a thermal shield such its resonant mechanical structure is not affected by this temperature variation.

The inputs to the two resonant sensors 102a, 102b are connected to a periodic signal generator 104 applying an oscillation signal to the input to resonant sensors 102a, 102b for which the characteristics (frequency, amplitude) are such that the two resonant sensors 102a, 102b are resonant at the same frequency imposed by the signal generator 104. Furthermore, the two resonant sensors 102a, 102b may be powered from the same power supply voltage.

The measurement device 100 also comprises a phase comparator 108 that measures the phase shift between the signals output from the resonant sensors 102a, 102b. Thus, when the measurement device 100 is subjected to a variation of the variable to be measured (for example a mass variation applied on the measurement device 100), this variation results in a phase shift of the output signal from the second resonant sensor 102b relative to the output signal from the first resonant sensor 102a that is not affected by this variation of the variable to be measured.

However, this phase shift is representative of the variation of the measured variable. For example, in the case of the device 100 that will measure a mass, the phase shift Δφ between the output signals from the resonant sensors 102a, 102b is such that:

$$Δϕ = - arctan ( \frac{\frac{f}{{f}_{r} \cdot Q}}{1 - {( \frac{f}{{f}_{r}} )}^{2}} ) \qquad ( 5 )$$

where f: frequency of the signal output from the signal generator 104;

fᵣ: resonant frequency of the resonant sensors 102a, 102b;

Q: quality factor of the resonant sensors 102a, 102b.

However, the resonant frequency fᵣ is such that:

$${f}_{r} = \sqrt{\frac{k}{m}} \cdot \frac{1}{2 π } \qquad ( 6 )$$

where m corresponds to the sum of the initial mass m₀ of the mobile structure of the sensor and the variation of mass Δm to be measured;

k: stiffness of the mobile structure of the resonant sensor.

Therefore using formulas (5) and (6) above, it can be seen that the value of a variation Δm of the initial mass m₀ (where m=m₀+Δm) can be found from the measured phase shift Δφ.

The output signal from the phase comparator 108 is sent to the input using calculation means 110, for example comprising an electronic calculation circuit capable of calculating the value of the variation of the physical parameter to be obtained using the phase shift measured between the output signals from the resonant sensors 102a, 102b.

We will now refer to FIG. 4 which shows a second example embodiment of a measurement device 200 with resonant sensors capable of measuring a physical variable.

The measurement device 200 comprises a first resonant sensor 102a and a second resonant sensor 102b, for example similar to those described previously with reference to the measurement device 100.

Unlike the measurement device 100 in which the oscillation frequencies of the resonant sensors 102a, 102b are imposed by the signal generator 104, the resonant sensors 102a, 102b of the measurement device 200 receive the same signal at their input, output by a counter reaction loop produced with one of the resonant sensors 102a, 102b.

Thus, in the example in FIG. 4, each of the outputs from the resonators 102a, 102b are connected to the input of an amplifier 202a, 202b. The amplifiers 202a, 202b preferably have the same gain so that they will not cause any different phase shifts in the measurement device 200, and so that signals with the same amplitude will be applied at resonator inputs, which prevents the appearance of non-linear phenomena and does not disturb the measurement made. The output of the amplifier 202a is sent to the input of a phase shift circuit 204 the output of which is connected to the inputs to the two resonant sensors 102a, 102b.

Thus, the first resonant sensor 102a forms part of a self-oscillating loop capable of outputting a periodic signal, thus preventing the use of a signal generator. In the example described herein, the self-oscillating loop is formed with the first resonant sensor 102a insensitive to variations of the physical variable to be measured.

However, it is possible to make the self-oscillating loop of the measurement device 200 with the second resonant sensor 102b sensitive to variations of the physical variable to be measured.

Output signals from the two amplifiers 202a, 202b are sent to the inputs to the phase comparator 108, for example similar to the phase comparator of the measurement device 100, so that the phase shift of the output signals from the amplifiers 202a, 202b can be measured relative to each other, this phase shift being similar to the phase shift obtained between signals output from the resonant sensors 102a, 102b. As for the measurement device 100, the measurement of this phase shift is then sent to the input of the calculation means 110 to calculate the value of the physical parameter measured from the phase shift obtained.

Refer to FIG. 5 that shows a third example embodiment of a resonant sensor measurement device 300 that can measure a physical variable.

The measurement device 300 comprises a first resonant sensor 102a and a second resonant sensor 102b, for example similar to those previously described with reference to the measurement devices 100 and 200.

Unlike the measurement device 100 in which the oscillation frequencies of the resonant sensors are imposed by the signal generator 104, the resonant sensors 102a, 102b of the measurement device 300 are powered by a counter reaction made with each of the resonant sensors.

These counter-reactions are made through a differential amplifier 302. The output of the first resonant sensor 102a is connected to the non-inverting input or positive input of the differential amplifier 302 and the output of the second resonant sensor 102b is connected to the inverting input or negative input of the differential amplifier 302.

The non-inverting output of the differential amplifier 302 is connected to the input of the second resonant sensor 102b and the inverting output of the differential amplifier 302 (the value of which is equal to the inverted value of the non-inverting output, therefore the inverting and non-inverting outputs from the differential amplifier 302 have a phase shift of n relative to each other) is connected to the input of the first resonant sensor 102a.

A capacitor 304a, 304b is connected to each of the electrical connections connecting one of the outputs from the differential amplifier 302 to the input of one of the resonant sensors 102a, 102b, and the ground. These capacitors 304a, 304b cause a phase shift of −n/2 in the retroaction loops, thus balancing the phase shifts applied to the signals through the counter-reaction loops (each resonator also introduces a phase shift of −n/2). As a variant, the positions of the resonant sensors 102a, 102b can be inverted, the non-inverting input and the inverting output of the differential amplifier 302 being connected to the second resonant sensor 102b, the inverting input and the non-inverting output of the differential amplifier 302 being connected to the first resonant sensor 102a.

The resonant sensors 102a and 102b of the measurement device 300 are such that they have the same resonant frequency under standard operating conditions, in other words when they are not affected by a variation of the physical variable to be measured by the device 300. When the measurement device 300 (and therefore the resonators 102a, 102b) is subjected to a variation of the variable to be measured, the power supply voltage of the resonators 102a, 102b applied to the power supply terminals 306a, 306b of sensors 102a, 102b must be different to keep the two resonant sensors 102a, 102b at the same resonant frequency, and to maintain a constant phase shift (in this case n) between the output signals from the two resonant sensors 102a, 102b, because only the second resonant sensor 102b is affected by this variation. Therefore, by expressing the resonant frequencies of the resonant sensors 102a, 102b according to equation (1) described above, we obtain:

fᵣ₁=fᵣ₀(1−αΔT−γΔV_{DC1}) (7)

fᵣ₂=fᵣ₀(1−αΔT−βΔm−γΔV_{DC2}) (8)

Where fᵣ₁ and fᵣ₂ correspond to the resonant frequencies of the first and the second resonant sensors 102a, 102b, V_{DC1} and V_{DC2} correspond to the power supply voltages of the first and the second resonant sensors 102a, 102b respectively. Using equations (7) and (8) above, since the resonant frequencies fᵣ₁ and fᵣ₂ are equal, it can be seen that the measurement of the physical variable (in this case the mass variation Δm) may be obtained by measuring the difference between the power supply voltages V_{DC2} and V_{DC1} used to maintain a constant phase shift between the output signals of the two resonant sensors 102a, 102b such that:

γ(ΔV_{DC2}−ΔV_{DC1})=βΔm (9)

Therefore since the values of the coefficients γ and β are known, it is possible to determine the value of Δm. The means of measuring the power supply voltages V_{DC2} and V_{DC1} are not shown in FIG. 5.

As a variant from the diagram shown in FIG. 5, the outputs from the resonant sensors 102a, 102b can be connected to the input of the phase comparator, for example similar to the phase comparator 108 previously described. The value of the output signal from the phase comparator can then be kept constant by the operator by adjusting one of the power supply voltages of the resonant sensors 102a, 102b. The value of the required mass variation is then obtained similarly, by measurement of the difference between V_{DC1} and V_{DC2}.

In another variant, it is possible to not adjust the power supply voltages of the resonant sensors 102a, 102b when the physical variable to be measured varies. In this case, the outputs from the resonant sensors 102a, 102b are connected to inputs to the phase shift measurement means between the output signals from the resonant sensors 102a, 102b, for example corresponding to a phase comparator similar to the phase comparator 108 described above. The output from phase comparator 108 is then sent to the input of the calculation means, for example corresponding to means 110 previously described, capable of calculating a variation of the required physical variable from the measured phase shift.

When the resonant frequencies of the two resonant sensors 102a, 102b are different under the same operating conditions of the device 300, the resonant sensors 102a, 102b are then operating at the same oscillation frequency between the two resonant frequencies of the two resonant sensors 102a, 102b, or outside this range, at a frequency close to one of these two resonant frequencies.

The measurement device 400 shown in the FIG. 6 can be made if the difference between the resonant frequencies of the two resonant sensors is greater such that no oscillations are created in the device 300. Unlike device 300 shown in FIG. 5, the measurement device 400 also comprises a phase comparator 402, the inputs of which are connected to the outputs from the two resonant sensors 102a, 102b. The output of the phase comparator 402 is connected to the input of a low pass filter 404, and then to an input of an adder 406. The power supply voltage V_{DC1} of the first resonant sensor 102 is applied to a second input of the adder 406. Finally, the output of the adder 406 is connected to the power supply terminal 306b of the second resonant sensor 102b.

Elements 402, 404 and 406 are used to slave the power supply voltage of the second resonant sensor 102b relative to the phase shift between the signals output from the two resonant sensors 102a, 102b. Thus, the resonant frequency of the second resonant sensor 102b is slaved to the resonant frequency of the first resonant sensor 102a so that the resonant frequencies of the two resonant sensors are identical when the measurement is made by the device 400. Equations (7), (8) and (9) presented above are then applicable to the device 400, the measurement of the required variable being deduced from the difference between the power supply voltages V_{DC1} and V_{DC2} of the two resonant sensors 102a, 102b necessary to keep the two resonant sensors 102a, 102b vibrating at the same resonant frequency.

1. A device for the measurement of at least one physical variable, comprising at least:
a first and a second resonant sensor, one of the two resonant sensors being sensitive to a variation of the physical variable to be measured and the other of the two resonant sensors not being sensitive to a variation of the physical variable to be measured;
means capable of imposing a same resonant frequency on the first and the second resonant sensors;
means of measuring a phase shift between the output signals from the first and the second resonant sensors;
in which the means capable of imposing the same resonant frequency on the first and the second resonant sensors comprise at least:
two amplifiers, the inputs of which are connected to outputs from the first and the second resonant sensors, and
a phase shift circuit, one input of which is connected to an output of one of the two amplifiers and one output of which is connected to the inputs to the first and second resonant sensors;
or in which the means capable of imposing the same resonant frequency on the first and the second resonant sensors comprise at least:
a differential amplifier comprising a non-inverting input connected to an output of the first resonant sensor, an inverting input connected to an output of the second resonant sensor, an inverting output connected to an input of the first resonant sensor, and a non-inverting output connected to an input of the second resonant sensor, and
a first capacitor connected to the inverting output of the differential amplifier, and a second capacitor connected to the non-inverting output of the differential amplifier;
and when the means of imposing the same resonant frequency onto the first and the second resonant sensors comprise said two amplifiers) and said phase shift circuit, the means of measuring the phase shift between the output signals from the first and the second resonant sensors are capable of measuring a phase shift between signals output onto the outputs from the two amplifiers.

2. A measurement device according to claim 1, in which the first and/or second resonant sensors are of the NEMS and/or MEMS type.

3. A measurement device according to claim 1, in which the physical variable that will be measured may be a mass, temperature, acceleration or pressure.

4. A measurement device according to claim 1, also comprising means of calculating a variation of said physical variable from the measured phase shift.

5. A measurement device according to claim 1, also comprising means of calculating a variation of the physical variable using a difference between values of the power supply voltage of the resonant sensors.

6. A measurement device according to claim 5, also comprising means capable of electrically powering one of the two resonant sensors by a power supply signal, the value of which depends on the value of a power supply signal from the other of the two resonant sensors and the phase shift between the output signals from the first and the second resonant sensors.

7. A measurement device according to claim 1, in which the measurement means that measure the phase shift between the signals output from the first and the second resonant sensors comprise at least one phase comparator.

8. The method for measuring the variation of at least one physical variable, comprising at least the following steps:
force the oscillation of a first and a second resonant sensor, at the same resonant frequency, one of the two resonant sensors being sensitive to a variation of the physical variable to be measured and the other of the two resonant sensors not being sensitive to the variation of the physical variable to be measured;
measurement of a phase shift between the output signals from the first and the second resonant sensors;
and in which the first and the second resonant sensors are put into oscillation at the same resonant frequency, as follows:
by applying the same signal output from a counter reaction loop made with the first or the second resonant sensor to the input of the first and the second resonant sensors, or
by applying a signal output from a counter reaction loop produced with the first and the second resonant sensors to the input of the first and the second resonant sensors respectively, and a differential amplifier to which the output signals from the first and the second resonant sensors are input.
